(19) United States
(12) Patent Application Publication
(10) Pub. No.: US 2006/0142056 A1
(43) Pub. Date: Jun. 29, 2006

(54) Digital broadcast receiver

(75) Inventors: Yuriko Suenaga, Osaka (JP); Naoki Matsuo, Osaka (JP); Ai Matsuzaki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 11/261,786

(22) Filed: Oct. 31, 2005

(30) Foreign Application Priority Data
Dec. 9, 2004 (JP) 2004-357423

(51) Int. Cl. H04M 1/00

(52) U.S. Cl. 455/556.1

(57) ABSTRACT

The present invention provides a digital broadcast receiver which can prevent the user from mistaking blackout status for trouble with the digital broadcast receiver as much as possible. In cases where the AV decoder 4 cannot receive the IDR frame because of a bad broadcast transmission, it is possible that nothing is displayed on screen of the display section 36. In this invention, when in an undisplayable status because of a bad broadcast transmission (the CPU 13 receives the impossiblity notification of the decoding from AV decoder 4, the error correction from the tuner 2 or the CPU 13 decides that broadcast wave receiving is impossible based on the receiving electrical field strength, etc.), the display section 36 displays a message by the OSD circuit 12. This message describes the undisplayable status, for example, “Cannot display video because of a receiving failure,” when there is a bad broadcast transmission.

### CROSS REFERENCE TO RELATED APPLICATIONS

This application is based upon and claims priority of Japanese Patent Application No. 2004-357423, the contents of which are incorporated herein by reference.

### BACKGROUND OF THE INVENTION

1. Field of the Invention

The present invention relates to a digital broadcast receiver which receives terrestrial digital broadcast.

2. Description of the Related Art

If a broadcast transmission status becomes bad, interference is introduced into the received image in the case of the conventional terrestrial analog broadcast. On the other hand, there is no such interference on the received image in the case of a terrestrial digital broadcast (Refer to Japanese Tokkai 2004-208149).

As discussed above, a user may know bad broadcast transmission status from the interference on the received image in the case of conventional terrestrial analog broadcast. A user may think the apparatus is malfunctioning because of sudden black out of images on the display in the case of terrestrial digital broadcast. Especially since people usually use the mobile terrestrial digital broadcast receiver while moving, it is expected that blackout status because of a receiving failure may occur frequently.

### SUMMARY OF THE INVENTION

In view of the foregoing circumstances, an object of the present invention is to provide the digital broadcast receiver which can prevent the user from mistaking blackout status for trouble with the digital broadcast receiver as much as possible.

In order to solve the above problem, the preferred embodiment of the invention displays at least one of a message, a still picture or an animation picture indicating the undisplayable status because the receiving status of the broadcast wave has become worse. (Hereafter called first configuration)

In accordance with the first configuration, if the blackout status occurs because of a receiving failure, it is able to prevent the user from believing that the apparatus is malfunctioning because the message, the still image or the animation are displayed on screen.

Moreover, another preferred embodiment of the invention comprises following: a determiner for determining a display impossibility because of the bad broadcast transmission, a memory for storing a last received picture temporarily, a display controller for displaying a last received picture read from the memory if said determiner decides the display impossibility. (Hereafter called second configuration)

In accordance with the second configuration, in another preferred embodiment of the invention, if the undisplayable status of received picture occurs, the broadcast receiver displays the last received picture read in the memory. Then the user is able to know the undisplayable status because the receiving status of the broadcast wave has become worse.

In the second configuration, the digital broadcast receiver also produces a picture based on said last received picture and newly received picture data if it is able to receive the digital broadcast wave after the undisplayable status. Moreover, in the second configuration, the digital broadcast receiver further includes a means for measuring time of the undisplayable status. The broadcast receiver conducts a fade-out process that slowly changes the displayed image into a nondisplay, if it is not able to receive digital broadcast wave due to a continuing the undisplayable status.

In these configurations including the fade-out process, the fade-out process decreases a display brightness slowly. Moreover, in these configurations including the fade-out process replaces said displayed picture with any still picture or animation picture slowly. The broadcast receiver further includes a picture memory for storing any still picture or animation picture, the broadcast receiver displays said any still picture or animation picture read from said picture memory, if the display brightness is less than a predetermined value.

Moreover, another preferred embodiment of the present invention provides that the broadcast receiver is a handheld type or mobile type, and receives a terrestrial digital broadcast.

### BRIEF DESCRIPTION OF THE DRAWINGS

The above and other objects and advantages of the present invention will become apparent and more readily appreciated from the following description of the preferred embodiments taken in conjunction with the accompanying drawings, of which:

FIG. 1 is a function block diagram of a cellular phone which is preferably used in accordance with embodiments of the present invention.

FIG. 2 is a function block diagram of a broadcast receiver section of the cellular phone which is preferably used in accordance with embodiments of the present invention.

### DETAILED DESCRIPTION OF THE PREFERRED EMBODIMENTS

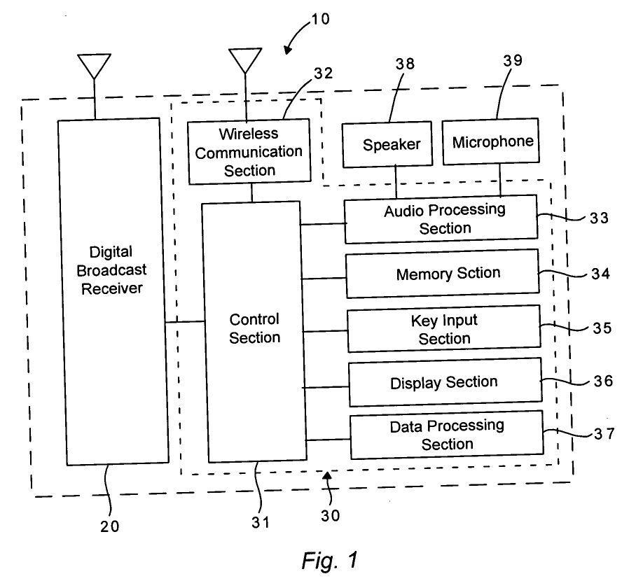

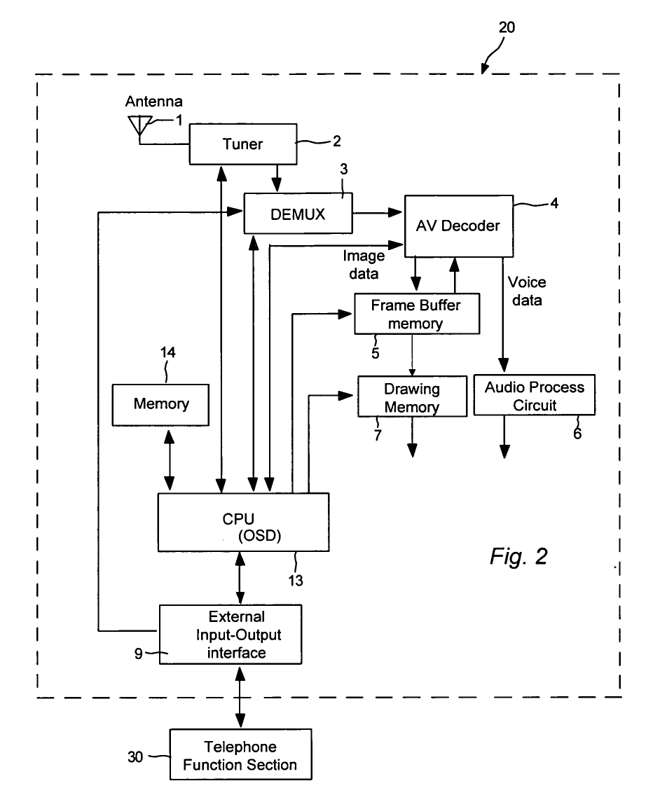

The digital broadcast receiver of the preferred embodiments of the present invention will be explained in accordance with FIG. 1 and FIG. 2. As the preferred embodiment, a cellular phone with a terrestrial digital TV broadcast receiver will be described.

FIG. 1 shows a function block diagram of the cellular phone with a TV function 10. The cellular phone with TV function 10 has a telephone function 30 and a digital broadcast receiver 20. The telephone function section 30 has a control section 31, a wireless communication section 32, an audio processing section 33, a memory section 34, a key input section (operating section)) 35, a display section 36 (for example LCD (Liquid Crystal Display) and a data processing section 37. The received audio signal in a usual telephone process is provided to a speaker 38 through an audio processor 33. On the other hand, a voice from a user is converted into an audio signal by microphone 39 then the audio signal is amplified and processed by the audio signal processor 33. The processed audio signal is transmitted by the wireless communication section 32. A data processor 37 processes the received packet. The wireless communication section 32 conducts the sending/receiving processes of voice and data and predetermined protocol processes, that is, a sending process and a receiving process between a base station and cellular phone 10. The control section 31 controls all parts of the telephone function section 30 and also controls a communication between the telephone function section 30 and the digital broadcast receiver 20. For example, as a basic processing, the control section 31 provides an “On signal” to the digital broadcast receiver 20 if a TV function start key is operated in the key input section 35. The control section 31 further provides an image signal from the digital broadcast receiver 20 to the display 36. The control section also conducts an operation to provide a channel select order that designates a number of an operated key as a channel number for the digital broadcast receiver 20.

Next, the digital broadcast receiving section 20 is explained based on FIG. 2. A terrestrial antenna 1 supplies a terrestrial digital tuner 2 with a received signal. The terrestrial digital tuner 2 takes out a specific frequency signal from the high frequency digital modulation signals having image and audio data. Moreover, the terrestrial digital tuner 2 has a de-modulator circuit, a reverse interleave circuit, an error correction circuit, etc. The terrestrial digital tuner 2 de-modulates the selected digital modulated signal and provides a transport stream.

A de-multiplexer(DEMUX) 3 divides said transport stream into a video stream, an audio stream, PSI/SI (Program Specific Information/Service Information), and a broadcast information (the local identifier, the type of services, the broadcast station discernment, the service number) on IEEE (Institute of Electrical and Electronic Engineers). The de-multiplexer 3 provides a video stream and an audio stream to an AV decoder 4 and further provides PSI/SI, the broadcast information, etc. (this information is called the program information) to the CPU 13.

An AV decoder 4 has a video decoder in which the video stream is decoded and an audio decoder in which the audio stream is decoded. The video decoder decodes an input code signal and calculates a quantization factor and a motion vector, then conducts reverse-DCT (Discrete Cosine Transform) conversion, motion compensation control in accordance with the motion vector, etc. Audio data produced by the decoder is provided to a frame buffer memory 5. The audio data is then provided to an audio processing circuit 6.

The frame buffer memory 5 receives the last one frame of the video data from the AV decoder 4, then provides the last one frame to a drawing memory 7 (VRAM (Video Random Access Memory)). The contents of the drawing memory 7 (VRAM) is displayed on display 36. The audio processing circuit 6 receives the audio data from the AV decoder 4, then conducts D/A conversion and produces, for example, Right (R) and Left (L) audio analog signals. These audio analog signals are provided to an external speaker (not shown) or the speaker 38 for communication.

The memory 14, that is, for example, RAM (Random Access Memory), EEPROM (Electrically Erasable Programmable Read-Only Memory), Flash Memory, etc., contains a channel table, that is, a channel list in which frequency information, a station name and other information corresponding to a remote-control key ID and channel number. Further, the memory 14 contains still picture files and animation files.

The CPU 13 has an OSD (On Screen Display) function and writes video data based on character information and color information in the drawing memory 7 (VRAM). The CPU 13 also reads still picture files and animation files stored in the memory 14, then CPU 13 is able to write them into the drawing memory 7 (VRAM). Moreover, the CPU 13 interchanges information with the telephone function section 30 through an external input-output interface 9. The CPU 13, further, is able to conduct the channel selection and other operations utilizing a channel search process by the digital broadcast receiver 20 and its result, namely, the channel table.

As referred to above, the broadcast data has a Transport Stream comprising a fixed-length data called a Transport Stream (TS) Packet. A PID (Packet Identifier), which indicates a type of data such as video data, audio data, or the like, is allocated on each TS packet. The de-multiplexer 3 separates the data in accordance with the PID.

In a broadcast for cellular phone of the terrestrial digital broadcast, a video encoding is the H.264 on IEEE. The frame on H.264 has an IDR (Instantaneous Decoder Refresh) frame (independence frame) and non_IDR frame (accompanying frame). If the AV decoder 4 decodes IDR frame which guarantees usually decoding, IDR frame is needed to be decoded certainly.

In the case that the IDR frame is not received because of bad broadcast transmission status, nothing may be displayed on the display 36. In accordance with the embodiment of the invention, a message displayed by utilizing an OSD function is achieved if it is impossible to display any received image because the receiving status of the broadcast wave has become worse. This occurs when the CPU 13 receives a notice of an un-decodable frame from the AV decoder 4 or a notice of un-correctable error from the tuner 2, and it is impossible for the CPU 13 to receive the broadcast wave based on the receiving wave strength signal from the tuner 2. This message is, for example, “Impossible to display any images because of interference of receiving operation.” The message means that it is impossible to display any received images because the receiving status of the broadcast wave has become worse. Such a message may be displayed in a pop-up window (or in a balloon.). Further, the CPU 13 may display both a character still image read out from the memory 14 and the message in the pop-up window as if the character is talking. Such a message may also be displayed in the pop-up window with a character animation image as if the character is talking. Instead, only the character still image or the character animation image may be displayed with a troublesome face or action that means received images are now un-displayable because of a bad receiving status of the broadcast wave.

As described above, if the blackout status occurs because of the receiving failure, the user is prevented from believing that the apparatus is malfunctioning because the message, the still image and animation are displayed on screen.

The display section 36 may display the last video data received before the receiving failure with the above message or without the above message. As above, the frame buffer memory 5 always contains the last one frame of decoded video data. Moreover, if the receiving failure occurs, the CPU 13 stops the audio data produced by the AV decoder 4 from being written to the frame buffer memory 5. Therefore, if the receiving failure occurs, the user is able to know the broadcast transmission status has become bad because the display 36 displays the last received still picture.

Moreover, the cellular phone with a TV function 10 may have a timer (not shown). When the receiving failure occurs, the timer is activated. When the digital broadcast receiver returns to the receiving status within a predetermined time, if the received frame is a non_IDR frame, the CPU 13 reads the last received video data from the frame buffer memory 5, and then provides the last still picture to the AV decoder 4. The AV decoder 4 produces (decodes) the picture from the difference between the latest received still image and the non_IDR frame. The produced picture is different from an original picture based on the difference between the last received still picture and the original IDR frame. However, it is possible to produce a picture like an original picture if the predetermined time is comparatively short.

In the case that the digital broadcast receiver does not return to the receiving status, the last received still picture is displayed on display 36 and may conduct the fade-out process. The fade-out process may decrease the brightness gradually in the display section 36, and turn the screen to black. Or, the display 36 may display the standby screen that is read from the memory section 34 or the memory 14, after display 36 is in a blackout status. Or, the display section 36 may replace the last received still picture with the standby screen by changing dots of the last received still picture to the standby screen non-simultaneously. A method for replacement can adopt other methods (like flip a page, etc.). Moreover, the display 36 may display a special picture for the receiving failure (preset image or selected image by user) instead of the standby screen.

Moreover, for example, the frame buffer memory 5 stores a plurality of images (frame), when the failure of receiving occur, the plurality of images in the frame buffer memory 5 may be reproduced. The order of the reproduction may reproduce from new data or may reproduce from old data. Therefore instead of the still image, which might make the user uncomfortable the motion picture is played based on plurality of images in the frame buffer memory 5.

Moreover, in the embodiment explained above, the digital broadcast receiver is a cellular phone with a TV function. But the digital broadcast receiver may be a handheld or mobile digital broadcast receiver. Moreover, the digital broadcast receiver may be a fixed type terrestrial digital broadcast receiver.

Although a few preferred embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A broadcast receiver which receives a digital broadcast wave and displays a received picture on a display,
wherein said broadcast receiver displays at least one of a message, a still picture or an animation picture indicating an undisplayable status because the receiving status of the broadcast wave has become worse.

2. A broadcast receiver which receives a digital broadcast wave and displays a received image on a display comprising:
a memory for storing a last received picture temporarily, wherein said broadcast receiver displays said last received picture read from said memory if the receiving status of the broadcast wave has been worse.

3. The broadcast receiver according to claim 2, wherein said broadcast receiver produces the picture based on said last received picture and newly received image data if it is able to receive the digital broadcast wave after the undisplayable status.

4. The broadcast receiver according to claim 2, wherein said broadcast receiver conducts a fade-out process that slowly changes the displayed picture to a nondisplay, if it is not able to receive the digital broadcast wave after the undisplayable status.

5. The broadcast receiver according to claim 2, further comprising:
a timer for measuring time of the undisplayable status, wherein said broadcast receiver conducts a fade-out process that slowly changes the displayed image to a nondisplay, if it is not able to receive digital broadcast wave after the undisplayable status.

6. The broadcast receiver according to claim 4 or 5, wherein the fade-out process slowly decreases the brightness of the display.

7. The broadcast receiver according to claim 6, further comprising:
a picture memory for storing any still picture or animation picture,
wherein said broadcast receiver displays said any still picture or animation picture read from said picture memory if a display brightness is less than predetermined value.

8. The broadcast receiver according to claim 4 or 5, further comprising:
a picture memory for storing any still picture or animation picture,
wherein said fade-out process slowly replaces said displayed picture with any still picture or animation picture.

9. The broadcast receiver as in one of claims 1-5,
wherein the broadcast receiver is a handheld type or a mobile type, and receives a terrestrial digital broadcast.
